(19) United States
(12) Patent Application Publication
(10) Pub. No.: US 2016/0169067 A1
(43) Pub. Date: Jun. 16, 2016

(54) VARIABLE VALVE LIFT APPARATUS

(71) Applicant: Hyundai Motor Company, Seoul (KR)

(72) Inventors: Myungsik Choi, Seoul (KR); Won Gyu Kim, Seoul (KR); Young Hong Kwak, Suwon-si (KR)

(73) Assignee: Hyundai Motor Company, Seoul (KR)

(21) Appl. No.: 14/858,927

(22) Filed: Sep. 18, 2015

(30) Foreign Application Priority Data
Dec. 10, 2014 (KR) 10-2014-0177359

(51) Int. Cl. F01L 13/00; F01L 3/00; F16K 31/524

(52) U.S. Cl. CPC F01L 13/0031; F16K 31/52408; F01L 3/00; F01L 2003/11

(57) ABSTRACT

A variable valve lift apparatus operated to change lift of a valve provided to an engine may include an outer body having an inside space formed therein, an inner body arranged in the inside space of the outer body, the inner body being selectively secured to the outer body to make a lever motion centered on a lever motion pivot shaft together with the outer body as a cam rotates, a connection shaft arranged to pass through the first end of the outer body and the first end of the inner body to connect the outer body to the inner body, a lost motion spring provided to return the inner body rotated relative to the outer body centered on the connection shaft to an original position, and a latching device provided to the outer body for selectively securing the inner body to the outer body.

### CROSS-REFERENCE TO RELATED APPLICATION

The present application claims priority to Korean Patent Application No. 10-2014-0177359 filed Dec. 10, 2014, the entire contents of which is incorporated herein for all purposes by this reference.

### BACKGROUND OF THE INVENTION

1. Field of the Invention

The present invention relates to a variable valve lift apparatus. More particularly, the present invention relates to a variable valve lift apparatus operated by a mechanical gap adjusting device.

2. Description of Related Art

In general, an internal combustion engine generates power by combusting fuel and air in a combustion chamber. In this case, when the air is drawn in, an intake valve is operated by driving a camshaft, to draw the air into the combustion chamber while the intake valve is opened. When the air is exhausted, an exhaust valve is operated by driving the camshaft to exhaust the air from the combustion chamber while the exhaust valve is opened.

An optimum operation of the intake valve or the exhaust valve varies with a rotation speed of the engine. That is, depending on the rotation speed of the engine, an appropriate lift or valve opening/closing time is controlled. Thus, in order to embody an appropriate valve operation according to the rotation speed of the engine, a variable valve lift (VVL) apparatus is under research for embodying a lift of the valve to be varied with the rotation speed of the engine. As an example of the variable valve lift apparatus, there is an apparatus which has a plurality of cams provided on a camshaft for driving the valve with different lifts from one another, and the apparatus is operated to select a cam which drives the valve according to a situation.

However, if the plurality of cams is provided to the camshaft, a configuration for changing the cams to selectively operate the intake valve or the exhaust valve becomes complicated, and interference among constituent elements may occur. If the plurality of cams is operated independently for preventing the interference among the constituent elements from occurring, requiring one of the constituent elements for operating each of the cams, cost may increase.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a variable valve lift apparatus having advantages of valve lift change, embodying cylinder deactivation, and cost saving, and to providing a variable valve lift apparatus which may change valve lift.

Various aspects of the present invention are directed to providing a variable valve lift apparatus which may embody cylinder deactivation with the change of the valve lift, and to providing a variable valve lift apparatus which may save a cost.

According to various aspects of the present invention, a variable valve lift apparatus operated to change lift of a valve provided to an engine may include an outer body having an inside space formed therein, the outer body having a first end configured to have the valve connected thereto and a second end configured to have a lever motion rotation shaft provided thereto for making a lever motion as a cam rotates, an inner body arranged in the inside space of the outer body, the inner body having a first end rotatably connected to the first end of the outer body, for being selectively secured to the outer body to make the lever motion centered on a lever motion pivot shaft together with the outer body as the cam rotates, a connection shaft arranged to pass through the first end of the outer body and the first end of the inner body to connect the outer body to the inner body, a lost motion spring provided to return the inner body rotated relative to the outer body centered on the connection shaft to an original position, and a latching device provided to the outer body for selectively securing the inner body to the outer body, in which the inner body may be configured to make the lever motion centered on the connection shaft as a secured state of the inner body is selectively released as the cam rotates.

The inner body may form an inside space, and may further include a roller arranged in the inside space rotatably connected to the inner body for making rolling contact with the cam for the inner body to make the lever motion as the cam rotates.

The inner body may have a second end formed with a stopper projected from the second end of the inner body to be caught at the second end of the outer body when the inner body returns to an original position.

A gap adjusting device may be mounted to a cylinder head as the gap adjusting device is inserted in a pivot hole formed in the cylinder head, a length of the gap adjusting device, which embodies a predetermined gap of the valve, may be selected according to a depth of the pivot hole, and one of a plurality of gap adjusting devices which are fabricated to have different lengths from one another in advance having a selected length may be inserted in the pivot hole.

A gap adjusting device may be mounted to a cylinder head as the gap adjusting device is inserted in a pivot hole formed in the cylinder head, and may further include a shim interposed between the gap adjusting device and the pivot hole for adjusting a height of the gap adjusting device.

A length of the gap adjusting device which embodies a predetermined gap of the valve may be selected according to a depth of the pivot hole, one of shims which are fabricated to have different lengths from one another in advance which embodies a selected length of the gap adjusting device may be inserted in the pivot hole, and the gap adjusting device may be inserted on the shim to make a sum of a selected length of the gap adjusting device be a length of the shim and a length of the gap adjusting device.

The lost motion spring may be arranged to be wound on the connection shaft to have a portion secured to the outer body and an end secured to the inner body.

The outer body and the connection shaft may be formed as one unit, and the lost motion spring may have a portion secured to the connection shaft to secure the lost motion spring to the outer body.

The lost motion spring may have a portion secured to the first end of the outer body extended without interference with the inner body.

The gap adjusting device may be a mechanical gap adjusting device which manually adjusts the valve gap.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a top plan view of an exemplary variable valve lift apparatus in accordance the present invention.

FIG. 2 illustrates a back side view of an exemplary variable valve lift apparatus in accordance with the present invention.

FIG. 3 illustrates a perspective view of an inner body of an exemplary variable valve lift apparatus in accordance with the present invention.

FIG. 4A, FIG. 4B, and FIG. 4C illustrate sections showing a process for assembling a gap adjusting device in an exemplary variable valve lift apparatus in accordance with the present invention.

FIG. 5 illustrates a schematic view of a gap adjusting device in an exemplary variable valve lift apparatus in accordance with the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

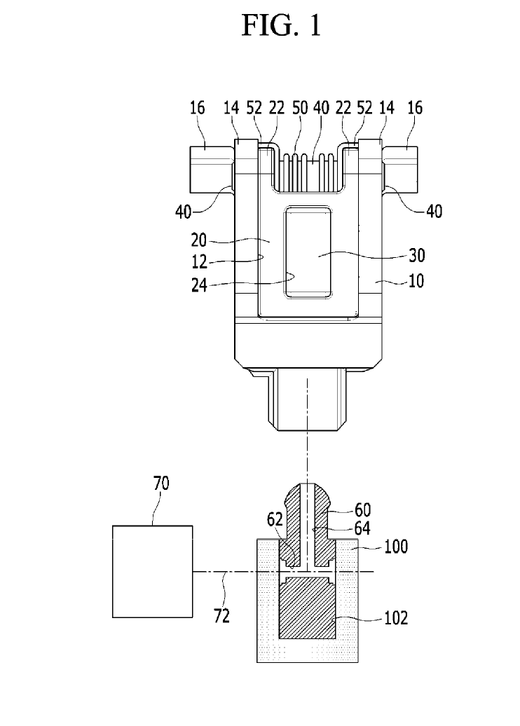

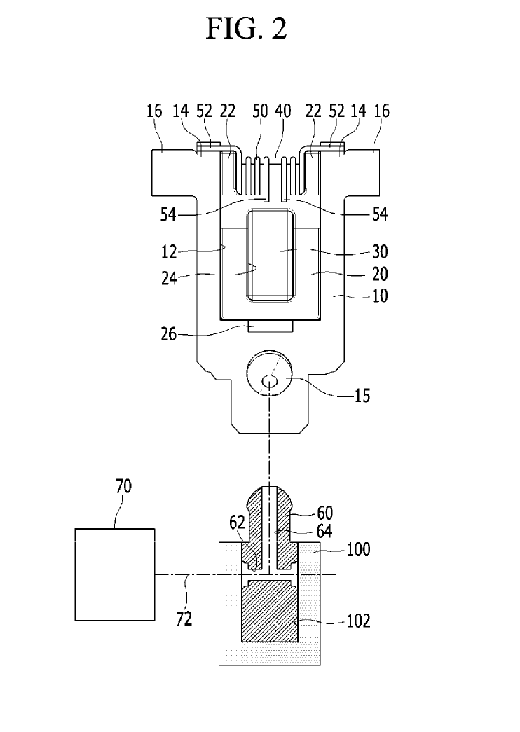

FIG. 1 illustrates a top plan view of a variable valve lift apparatus in accordance with various embodiments of the present invention, and FIG. 2 illustrates a back side view of a variable valve lift apparatus in accordance with various embodiments of the present invention.

Referring to FIG. 1 and FIG. 2, the variable valve lift apparatus includes an outer body 10, an inner body 20, a roller 30, a connecting shaft 40, a lost motion spring 50, and a gap adjusting device 60.

The outer body 10 may have a torque of a camshaft selectively forwarded thereto to make a lever motion to open/close a valve. The camshaft has a cam formed or provided thereto for converting a rotation of the camshaft to a lever motion of the outer body 10. In this case, the valve is an intake valve or an exhaust valve of an engine. Moreover, the outer body 10 has a pass-through inside space 12 formed therein in a vertical direction. That is, the outer body 10 has a predetermined length to make the lever motion, and predetermined width and thickness for forming the inside space 12 of the outer body 10.

The outer body 10 has one end connected to the valve, and the other end with a lever motion rotation shaft provided thereto. Further, since the inside space of the outer body 10 is opened at one end of the outer body 10, an overall shape of the outer body 10 may be formed to have a “U” shape.

In the following description, ends of constituent elements provided or connected to the outer body 10 are portions of the constituent elements in the same direction as the one ends of the outer body 10, respectively.

The inner body 20 is arranged in the inside space 12 of the outer body 10. One end of the inner body 20 is rotatably connected to one end of the outer body 10. One end of the inner body 20 has the torque of the camshaft forwarded thereto to make a lever motion to selectively open/close the valve. The inner body 20 has a pass-through inside space formed therein in a vertical direction. That is, the inner body 20 has a predetermined length to make the lever motion, and predetermined width and thickness to form an inside space 24 of the inner body 20.

The roller 30 is arranged in the inside space 24 of the inner body 20. The roller 30 is rotatably connected to the inner body 20. The roller 30 is in rolling contact with the cam for converting the rotation of the camshaft to the lever motion of the outer body 10 or the inner body 20.

The connecting shaft 40 is provided to rotatably connect one end of the outer body 10 to one end of the inner body 20. That is, the inner body 20 may rotate centered on the connecting shaft 40 relative to the outer body 10. In this case, one end of the outer body 10 connected to the inner body 20 with the connecting shaft 40 is called an outer connection 14, and one end of the inner body 20 connected to the outer body 10 with the connecting shaft 40 is called an inner connection 22.

The connecting shaft 40 is arranged to pass through the outer connection 14 of the outer body 10. That is, the outer connection 14 of the outer body 10 has an outer connection hole 18 formed therein for inserting the connecting shaft 40 therein. As the outer connection 14 has a valve contact portion 16 formed projected to both sides of a width direction of the outer connection 14, an entire width of the outer body 10 except the valve contact portion 16 and a length of the connecting shaft 40 may be reduced.

The outer body 10 has one end with the valve contact portion 16 formed projected from the outer connection 14. The valve contact portion 16 functions to push the valve according to the lever motion of the outer body 10 in contact with the valve or a valve opening/closing device provided to open/close the valve.

In this case, the outer connection 14 is formed on both sides of the inside space 12 in a width direction of the outer body 10, and the valve contact portion 16 is projected from both sides outer connections 14, respectively, to push two valves. The outer connection 14 has the other end with a seating recess 15 formed therein.

If the inner body 20 is secured to the outer body 10, the inner body 20 and the outer body 10 make the lever motion together while centered on a lever motion rotation axis of the outer body 10 to embody normal lift as the cam which is in rolling contact with the roller 30 rotates. If the inner body 20 which is secured to the outer body 10 is released from the outer body 10, only the inner body 20 makes the lever motion centered on the connecting shaft 40 to embody zero lift as the cam which is in rolling contact with the roller 30 rotates. In this case, the securing and the releasing of the inner body 20 which is selectively secured to the outer body 10 by using a latching pin or the like is apparent to a person of ordinary skill in the art, so no more detailed description will be provided.

The lost motion spring 50 functions to return the inner body 20 to an original position by the lever motion if the inner body 20 secured to the outer body 10 is released from the outer body 10. The lost motion spring 50 is arranged to be wound on the connecting shaft 40.

The lost motion spring 50 has an outer securing portion 52 secured to the outer body 10 and an inner securing portion 54 secured to the inner body 20. The outer securing portion 52 may have an extension in a width direction of the outer body 10 secured to the outer connection 14 of the outer body 10 for preventing interference with the inner body 20.

Since the lost motion spring 50 is arranged to be wound on the connecting shaft 40, the lost motion spring 50 may be easily secured to the inner body 20, and no additional element is required for connecting the lost motion spring 50 to the outer body 10 or the inner body 20. For example, if the lost motion spring 50 is arranged to be wound on the lever motion rotation axis of the outer body 10, and the lost motion spring 50 has a portion connected to the inner body 20 through a rotation shaft of the roller 30, the rotation shaft of the roller 30 will become longer, and a separate element may be required for making the lost motion spring 50 to be wound on the rotation shaft of the lever motion of the outer body 10.

The gap adjusting device 60 is seated in the seating recess 15. The gap adjusting device 60 adjusts a gap between the valve and the variable valve lift apparatus. Moreover, the gap adjusting device 60 is a Mechanical Lash Adjuster (MLA). In this case, since a basic function of the MLA 60 of manual adjustment of a gap of the valve is apparent to a person of ordinary skill in the art, detailed description thereof will be omitted.

If the MLA is applied to the gap adjusting device 60, a passage of hydraulic oil supplied to adjust the valve gap is eliminated, and cost may be saved in comparison to a case when a Hydraulic Lash Adjuster (HLA) is applied. If the MLA is applied to the gap adjusting device 60, the variable valve lift apparatus may be prevented from being brought into contact with a base of the cam. That is, even in a case when zero lift is embodied, the cam and the outer body 10 are not brought into rolling contact.

For example, when the HLA is applied, since the outer body 10 and the cam are brought into contact, a portion of the outer body 10 brought into contact with the cam may be worn. In general, the portion of the outer body 10 brought into contact with the cam is called a pad portion, and as the pad portion is worn, a preset height of a ramp of a cam profile may not be embodied. Moreover, if durability is taken into account, it is required to form the pad portion on the outer body 10. However, if the MLA is applied to the gap adjusting device 60, such a drawback may be prevented in advance.

In other words, even when the zero lift is embodied, since the cam and the outer body 10 are not in rolling contact, the outer body 10 in accordance with various embodiments of the present invention may have the pad portion eliminated therefrom. Likewise, the base of the cam which embodies the zero lift of the valve may be eliminated.

As the gap adjusting device 60 is inserted in a pivot hole 102 formed in a cylinder head 100, the gap adjusting device 60 is mounted to the cylinder head 100. The gap adjusting device 60 is connected to a hydraulic pressure supply unit 70 which generates the hydraulic pressure the variable valve lift apparatus requires for operation.

The hydraulic pressure supply unit 70 supplies the hydraulic pressure to the gap adjusting device 60 through an oil line 72, and the gap adjusting device 60 has an oil line connection hole 62 and a hydraulic pressure supply hole 64 formed therein.

The oil line connection hole 62 is in communication with the hydraulic pressure supply unit 70 through the oil line 72, and the hydraulic pressure supply hole 64 is a branch from the oil line connection hole 62 for supplying the hydraulic pressure to the outer body 10. That is, the hydraulic pressure supply hole 64 has an extension toward the seating recess 15 in the outer body 10.

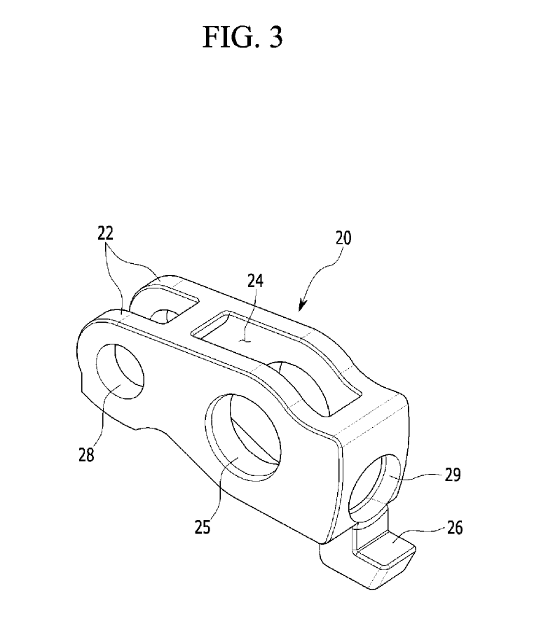

FIG. 3 illustrates a perspective view of an inner body of a variable valve lift apparatus in accordance with various embodiments of the present invention.

As shown in FIG. 3, the inner body 20 further includes a stopper 26, an inner connection hole 28, a roller hole 25, and a latching pin hole 29.

The stopper 26 is formed projected from the other end of the inner body 20 such that the other end of the inner body 20 is caught at the other end of the outer body 10 when the inner body 20 arrives at the original position by the lost motion spring 50 (see FIG. 2). Therefore, the inner body 20 may be securely returned to the original position by the lost motion spring 50.

The inner connection hole 28 is formed for the connecting shaft 40 arranged to pass through the inner connection 22 to be inserted therein, and the roller hole 25 is for the rotation shaft of the roller 30 to be inserted therein. That is, the inner connection hole 28 and the roller hole 25 are formed to pass through the inner body 20 in a width direction thereof.

The latching pin hole 29 is for a securing member, such as the latching pin which functions to selectively secure the inner body 20 to the outer body 10, to be inserted therein. As the securing member is inserted in the latching pin hole 29 by the hydraulic pressure supplied through the hydraulic pressure supply hole 64, the inner body 20 may be secured to the outer body 10, or as the securing member is released from a state of being inserted in the latching pin hole 29 by the hydraulic pressure supplied through the hydraulic pressure supply hole 64, the inner body 20 may be released from a state in which the inner body 20 is secured to the outer body 10.

In the meantime, by machining both of the outer body 10 and the inner body 20 with reference to the stopper 26, a tolerance between the securing member and the latching pin hole 29 may be precisely optimized.

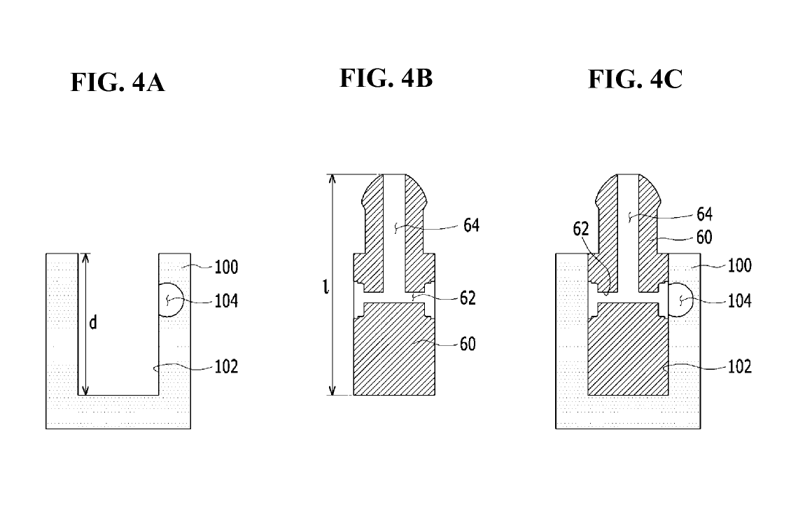

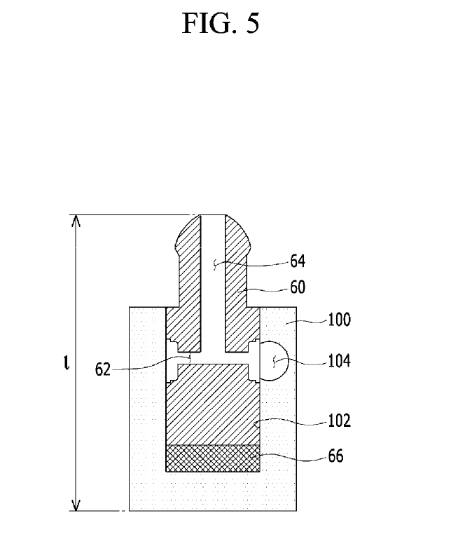

A method for adjusting a gap of a valve by using the gap adjusting device 60 will be described with reference to FIG. 4A, FIG. 4B, FIG. 4C, and FIG. 5.

FIG. 4A to FIG. 4C illustrate sections showing a process for assembling a gap adjusting device in a variable valve lift apparatus in accordance with various embodiments of the present invention.

A method for adjusting a gap of a valve by using the gap adjusting device 60 in accordance with various embodiments of the present invention will now be described.

At first, a depth d of the pivot hole 102 in the cylinder head 100 into which the gap adjusting device 60 is to be inserted is measured (see FIG. 4A).

Once the depth d of the pivot hole 102 is measured, a length l of the gap adjusting device 60 which may embody a predetermined gap of the valve is selected (see FIG. 4B).

When the length l of the gap adjusting device 60 is selected, one of the gap adjusting devices 60 which are fabricated to have different lengths from one another in advance having the length l selected thus is inserted in the pivot hole 102 (see FIG. 4C).

In the meantime, a number of gap adjusting devices 60 having different lengths from one another may be determined according to a design of a person of ordinary skill in the art.

FIG. 5 illustrates a schematic view of a gap adjusting device in a variable valve lift apparatus in accordance with various embodiments of the present invention.

As shown in FIG. 5, the gap adjusting device 60 has a shim 66 provided thereto.

The shim 66 is interposed between the gap adjusting device 60 and the pivot hole 102 for adjusting a height I of the gap adjusting device 60.

A method for adjusting a gap of a valve by using a gap adjusting device in accordance with various embodiments of the present invention will be described.

First, a depth d of a pivot hole 102 in the cylinder head 100 into which the gap adjusting device 60 is to be inserted is measured (see FIG. 4A).

If the depth d of the pivot hole 102 is measured, a length l of the gap adjusting device 60 which may embody a predetermined gap of the valve is selected (see FIG. 4B).

If the length of the gap adjusting device 60 is selected, one of the shims 66 fabricated to have different lengths from one another in advance, which may embody a selected length l, is inserted in the pivot hole 102 and the gap adjusting device 60 is inserted thereon (see FIG. 5). That is, the selected length l of the gap adjusting device 60 is a sum of the length of the shim 66 and the length of the gap adjusting device 60.

In this case, the gap adjusting device 60 may be fabricated to have a fixed length to embody the selected length with the selected shim 66, or the gap adjusting device selected from a plurality of the gap adjusting devices 60 fabricated in different lengths may embody the selected length l together with the selected shim 66.

A number of the gap adjusting devices 60 having different lengths may be determined according to a design of a person of ordinary skill in the art.

Referring to FIG. 4A, FIG. 4B, FIG. 4C, and FIG. 5, as the cylinder head 100 has a communication hole 104 formed therein for communication with the oil line 72, and the gap adjusting device 60 is fabricated to have the oil line connection hole 62 to be in communication with the communication hole 104, the oil line connection hole 62 and the oil line 72 are in communication.

Thus, according to various embodiments of the present invention, as two valve lifts are changed according to the lever motion of the inner body 20 which is in rolling contact with the cam, a power loss caused by friction with the cam may be minimized. Further, since only the inner body 20 which is in rolling contact with the cam makes the lever motion, cylinder deactivation may be embodied. Moreover, as the mechanical gap adjusting device 60 is applied, durability is improved and a configuration may become simple. Consequently, weight and cost may be saved.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings.

The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable valve lift apparatus operated to change lift of a valve provided to an engine, comprising:
an outer body having an inside space formed therein, the outer body having a first end configured to have the valve connected thereto and a second end configured to have a lever motion rotation shaft provided thereto for making a lever motion as a cam rotates;
an inner body arranged in the inside space of the outer body, the inner body having a first end rotatably connected to the first end of the outer body, for being selectively secured to the outer body to make the lever motion centered on a lever motion pivot shaft together with the outer body as the cam rotates;
a connection shaft arranged to pass through the first end of the outer body and the first end of the inner body to connect the outer body to the inner body;
a lost motion spring provided to return the inner body rotated relative to the outer body centered on the connection shaft to an original position; and
a latching device provided to the outer body for selectively securing the inner body to the outer body,
wherein the inner body is configured to make the lever motion centered on the connection shaft as a secured state of the inner body is selectively released as the cam rotates.

2. The apparatus of claim 1, wherein the inner body forms an inside space, and further includes a roller arranged in the inside space rotatably connected to the inner body for making rolling contact with the cam for the inner body to make the lever motion as the cam rotates.

3. The apparatus of claim 1, wherein the inner body has a second end formed with a stopper projected from the second end of the inner body to be caught at the second end of the outer body when the inner body returns to an original position.

4. The apparatus of claim 1, wherein a gap adjusting device is mounted to a cylinder head as the gap adjusting device is inserted in a pivot hole formed in the cylinder head, a length of the gap adjusting device, which embodies a predetermined gap of the valve, is selected according to a depth of the pivot hole, and one of a plurality of gap adjusting devices which are fabricated to have different lengths from one another in advance having a selected length is inserted in the pivot hole.

5. The apparatus of claim 1, wherein a gap adjusting device is mounted to a cylinder head as the gap adjusting device is inserted in a pivot hole formed in the cylinder head, and further includes a shim interposed between the gap adjusting device and the pivot hole for adjusting a height of the gap adjusting device.

6. The apparatus of claim 5, wherein a length of the gap adjusting device which embodies a predetermined gap of the valve is selected according to a depth of the pivot hole, one of shims which are fabricated to have different lengths from one another in advance which embodies a selected length of the gap adjusting device is inserted in the pivot hole, and the gap adjusting device is inserted on the shim to make a sum of a selected length of the gap adjusting device be a length of the shim and a length of the gap adjusting device.

7. The apparatus of claim 1, wherein the lost motion spring is arranged to be wound on the connection shaft to have a portion secured to the outer body and an end secured to the inner body.

8. The apparatus of claim 7, wherein the outer body and the connection shaft are formed as one unit, and the lost motion spring has a portion secured to the connection shaft to secure the lost motion spring to the outer body.

9. The apparatus of claim 7, wherein the lost motion spring has a portion secured to the first end of the outer body extended without interference with the inner body.

10. The apparatus of claim 7, wherein the gap adjusting device is a mechanical gap adjusting device which manually adjusts the valve gap.
